(19) United States
(12) Patent Application Publication
(10) Pub. No.: US 2015/0369066 A1
(43) Pub. Date: Dec. 24, 2015

(54) GAS TURBINE ENGINE WITH THERMOPLASTIC FOR SMOOTHING AERODYNAMIC SURFACES

(71) Applicant: United Technologies Corporation, Hartford, CT (US)

(72) Inventor: Thomas B. Hyatt, Cromwell, CT (US)

(73) Assignee: United Technologies Corporation, Hartford, CT (US)

(21) Appl. No.: 14/760,783

(22) PCT Filed: Feb. 4, 2014
(86) PCT No.: PCT/US14/14541

§ 371 Date: Jul. 14, 2015

Related U.S. Application Data
(60) Provisional application No. 61/762,909, filed on Feb. 10, 2013.

(51) Int. Cl. F01D 9/02; B05D 1/26; B05D 3/12; F01D 25/00

(52) U.S. Cl. CPC F01D 9/02; F01D 25/005; B05D 1/26; B05D 3/12

(57) ABSTRACT

A gas turbine engine has a surface configured for a gas flow path. The surface has at least one structural member defining a gap. A thermoplastic is deposited into the gap to smooth the surface, whereby the surface is aerodynamically and mechanically smoothly continuous over the gap area. A method is also disclosed.

### RELATED APPLICATION

This application claims priority to U.S. Provisional Application No. 61/762,909, filed Feb. 10, 2013.

### BACKGROUND OF THE INVENTION

This application relates to a method and apparatus wherein thermoplastic is deposited into areas of a gas flow path for a gas turbine engine to provide a smooth aerodynamic surface.

Gas turbine engines are known, and typically include a fan delivering air into a bypass duct, and into a core engine. A compressor sits in the core engine and receives the air flow. Compressed air is passed into a combustor where it is mixed with fuel and ignited, and products of this combustion pass downstream over turbine rotors driving them to rotate.

All of the surfaces within the gas turbine engine desirably have aerodynamic efficient shapes.

One particular location is in the bypass duct, wherein vanes are mounted to guide the air downstream of the fan. The vanes tend to be bolted into an outer housing, and spaced from other housings. In such structures, there are gaps. The gaps can reduce the efficiency of the overall engine, and thus is desirable to smooth these surfaces.

In the prior art, it is known to deposit room temperature vulcanizing materials into these gaps. However, the vulcanization process can take hours or days to set up and cure. Further, the curing releases volatile organic compounds (VOCs) and many assembly locations would desire not to have VOCs at the assembly location.

### SUMMARY OF THE INVENTION

In a featured embodiment, a gas turbine engine has a surface configured for being in a gas flow path, the surface having at least one structural member defining a gap. A thermoplastic is deposited into the gap to smooth the surface, whereby the surface is aerodynamically and mechanically smoothly continuous over a gap area.

In another embodiment according to the previous embodiment, the surface has at least two structural members spaced in an area defining the gap.

In another embodiment according to any of the previous embodiments, the gap is between a platform of a vane, and a spaced housing.

In another embodiment according to any of the previous embodiments, a second gap surrounds the head of a securement member.

In another embodiment according to any of the previous embodiments, a vane extends between a pair of inner and outer wall surfaces, and has platforms attached to each of the inner and outer wall surfaces. The gap includes recesses around a head of a securement member which secures the inner and outer platforms to associated housings.

In another embodiment according to any of the previous embodiments, the gap also includes a space between both the inner and outer platforms and an associated housing.

In another embodiment according to any of the previous embodiments, the vane sits in a bypass duct.

In another embodiment according to any of the previous embodiments, a vane extends between a pair of inner and outer wall surfaces, and has platforms attached to each of the inner and outer wall surfaces. The gap includes recesses around a head of a securement member which secures the inner and outer platforms to associated housings.

In another featured embodiment, a method of smoothing an aerodynamic surface in a gas turbine engine includes depositing a thermoplastic into a gap in a surface configured for being in a gas flow path, the surface including at least one structural member defining a gap. The surface is smoothed to remove excess thermoplastic to provide better aerodynamic efficiency whereby the surface aerodynamically and smoothly continuous over a gap area.

In another embodiment according to the previous embodiment, the surface includes at least two structural members spaced in the gap area.

In another embodiment according to any of the previous embodiments, the gap is between a platform of a vane, and a spaced housing.

In another embodiment according to any of the previous embodiments, the gap surrounds the head of a securement member.

In another embodiment according to any of the previous embodiments, a vane extends between a pair of inner and outer wall surfaces, and has platforms attached to each of the inner and outer wall surfaces. The gap includes recesses around a head of the securement member which secures the inner and outer platforms to associated housings.

In another embodiment according to any of the previous embodiments, the gap also includes a space between both the inner and outer platforms and an associated housing.

In another embodiment according to any of the previous embodiments, the vane sits in a bypass duct.

In another embodiment according to any of the previous embodiments, the gap surrounds the head of a securement member.

These and other features of this application may be best understood from the following specification drawings including the following which is a brief description.

### BRIEF DESCRIPTION OF THE DRAWINGS

FIG. 1 schematically shows a gas turbine engine.

FIG. 2 shows a vane mounted in a bypass duct.

FIG. 3A shows a first problematic location.

FIG. 3B shows the invention applied to the first problem area.

FIG. 4A shows a second problem area in a gas turbine engine.

FIG. 4B shows the invention applied to the second problem area.

FIG. 5A shows a first step in depositing thermoplastic.

FIG. 5B shows a final step.

### DETAILED DESCRIPTION

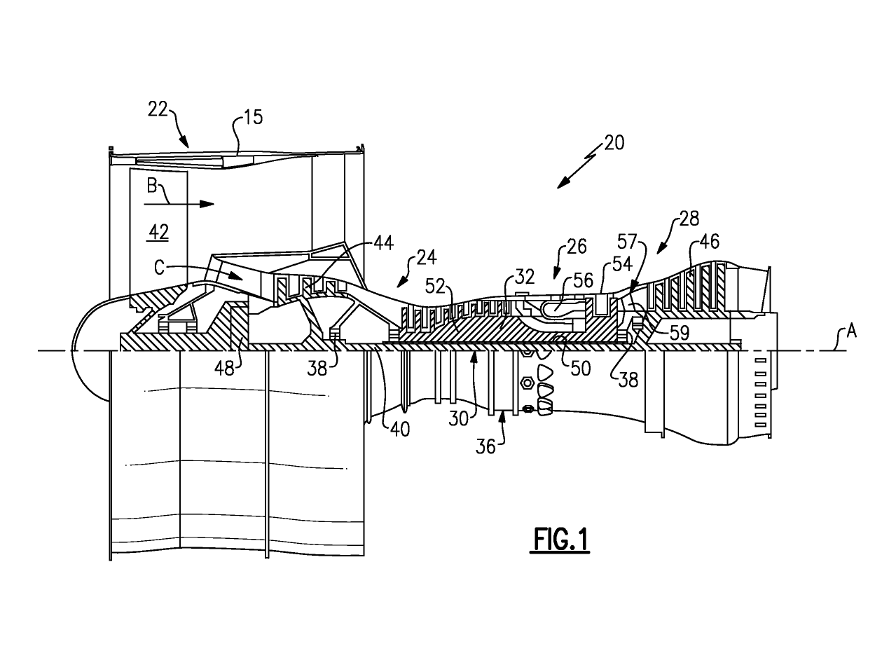

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a turbofan gas turbine engine in the disclosed non-limiting embodiment, it should be understood that the concepts described herein are not limited to use with turbofans as the teachings may be applied to other types of turbine engines including three-spool architectures.

The engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that interconnects a fan 42, a low pressure compressor 44 and a low pressure turbine 46. The inner shaft 40 is connected to the fan 42 through a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path. The turbines 46, 54 rotationally drive the respective low speed spool 30 and high speed spool 32 in response to the expansion.

The engine 20 in one example is a high-bypass geared aircraft engine. In a further example, the engine 20 bypass ratio is greater than about six (6), with an example embodiment being greater than ten (10), the geared architecture 48 is an epicyclic gear train, such as a planetary gear system or other gear system, with a gear reduction ratio of greater than about 2.3 and the low pressure turbine 46 has a pressure ratio that is greater than about 5. In one disclosed embodiment, the engine 20 bypass ratio is greater than about ten (10:1), the fan diameter is significantly larger than that of the low pressure compressor 44, and the low pressure turbine 46 has a pressure ratio that is greater than about 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.5:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7 ° R)]^{0.5}. The “Low corrected fan tip speed” as disclosed herein according to one non-limiting embodiment is less than about 1150 ft/second.

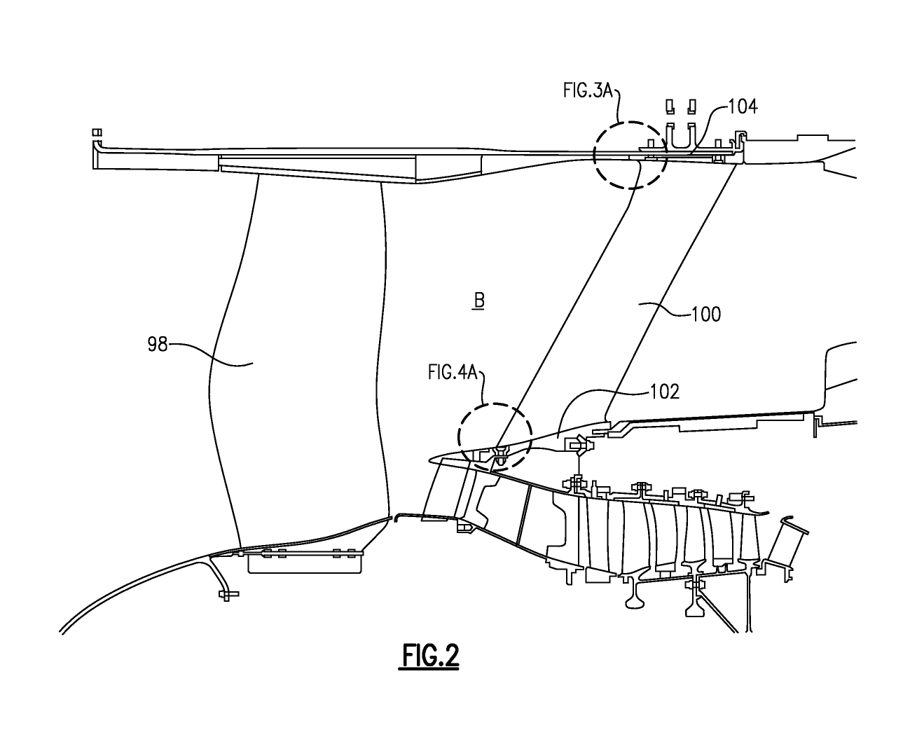

FIG. 2 shows a fan rotor 98 delivering bypass air E downstream into a bypass duct where it encounters a vane 100. This may be part of an engine such as shown in FIG. 1. As known, the vane 100 is mounted at an inner platform 102 and at an outer platform 104.

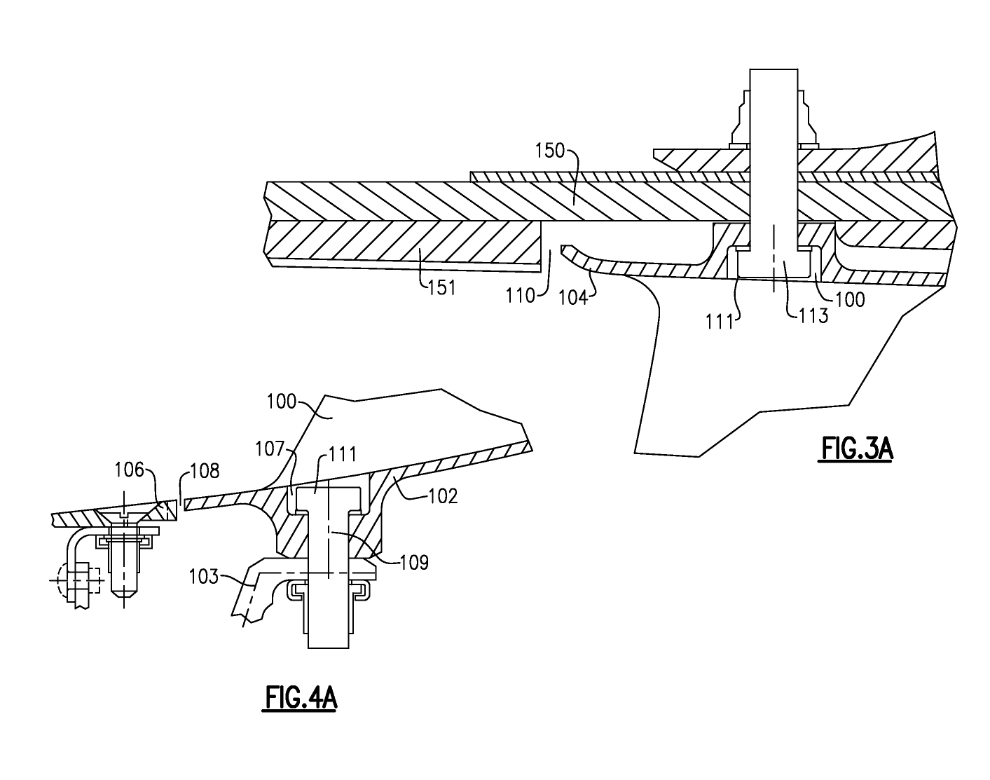

As shown in FIG. 3A, the outer platform 104 is spaced by a space 110 from an associated housing member 151. A bolt 113 secures the platform 104 to another housing 150. There is a gap 100 in a recess around the bolt head 113.

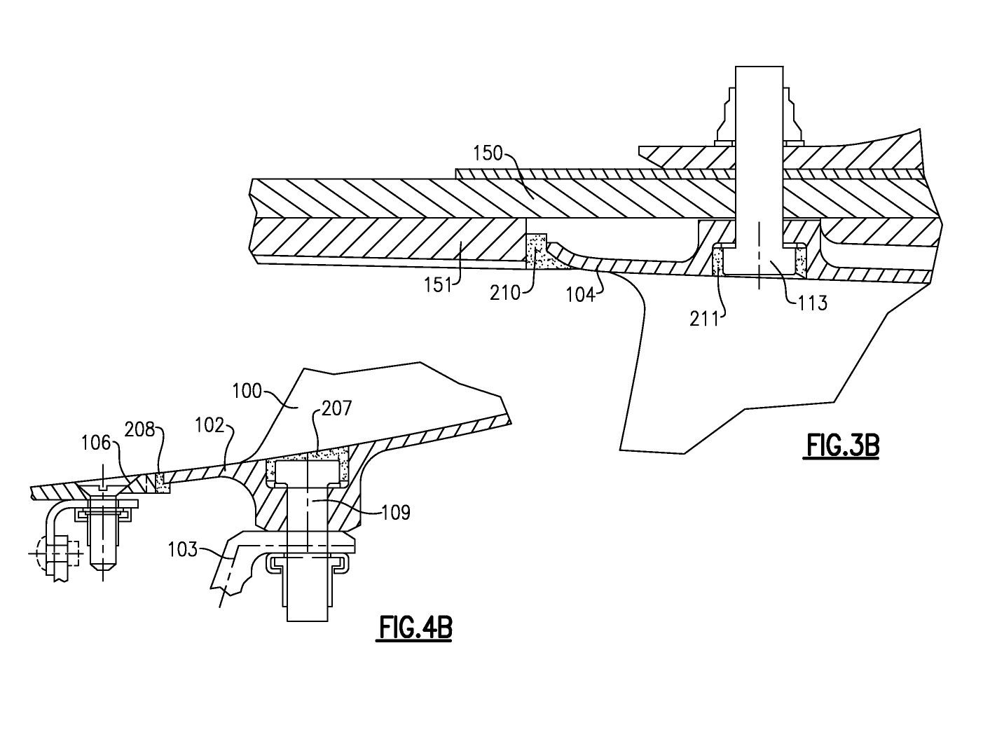

FIG. 4A shows a second problematic area wherein the inner platform 102 is spaced by a gap 108 from a forward housing member 106. A bolt 109 secures the platform 102 to a second housing member 103. There is a gap 107 about a head 111 of the bolt 109, as in the FIG. 3A embodiment.

While bolts 113 and 109 are shown, other securement members may be used.

FIG. 3B shows a material 210 that has been deposited into the gap 110, and material 211 filling the gap 111. Similarly, FIG. 4B shows materials at 208 and 207 filling the prior gaps 108 and 107.

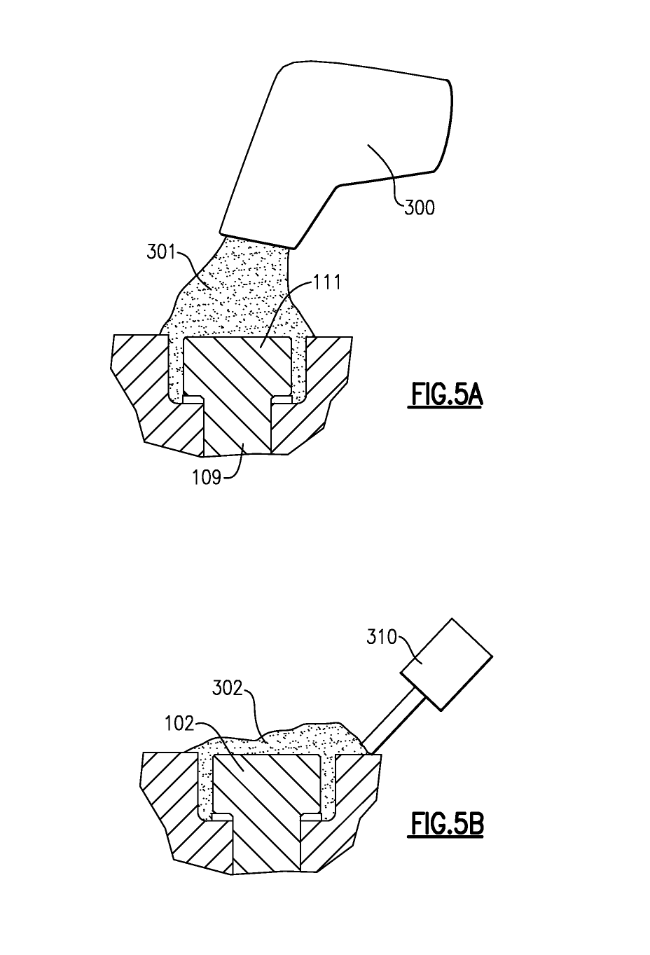

FIG. 5A shows the material which is deposited to fill the gaps 210, 211, 207 and 208, a thermoplastic. Thermoplastics are known that have melting temperatures well above the operating temperatures that would be seen in the bypass duct, as an example. There are commercially available systems which can deposit the thermoplastic into the gap.

As shown in FIG. 5A, a simple tool, such as a hot glue gun 300, can melt the thermoplastic such that it flows as shown in 301 into the recess about the head 111 of the bolt 109, as an example. The same process can be utilized at the other areas.

FIG. 5B shows a subsequent step, wherein a warm putty knife or other tool 310 is utilized to smooth off the surface such that the final smooth shape such as shown in FIG. 4B is reached.

A method of smoothing an aerodynamic surface in a gas turbine engine 20 includes the steps of depositing a thermoplastic into a gap 210, 211, 207, or 208 in a surface that will be part of a gas flow path when the gas turbine engine is operated. The surface has at least two structural members spaced by the gap. The surface is smoothed 310 to remove excess thermoplastic to provide better aerodynamic efficiency.

With this method, a gas turbine engine 20 has a surface configured for being in a gas flow path. The surface has at least two structural members spaced in an area defined by a gap 210, 211, 207 or 208. A thermoplastic is deposited into the gap to smooth the surface, whereby the surface is aerodynamically and mechanically smoothly continuous over the gap area.

In embodiments of this invention, the “structural members” could be the platform 104 and housing member 151, the platform 102 and housing member 106, or the bolts 109/113 and their associated platform. Of course, the term “structural members” can extend to many other components that may be found within a gas turbine engine. Notably, the term “structural” should not be interpreted to imply load bearing, but rather should be interpreted broadly. Finally, while the disclosed embodiments show a gap formed between two structural members, this application may extend to a gap formed within a single structural member.

Although an embodiment of this invention has been disclosed, a worker of ordinary skill in the art would recognize that certain modifications would come within the scope of this invention. For that reason, the following claims should be studied to determine the true scope and content.

1. A gas turbine engine comprising:
a surface configured for being in a gas flow path, the surface having at least one structural member defining a gap; and
a thermoplastic deposited into said gap to smooth the surface, whereby the surface is aerodynamically and mechanically smoothly continuous over a gap area.

2. The gas turbine engine as set forth in claim 1, wherein the surface has at least two structural members spaced in an area defining the gap.

3. The gas turbine engine as set forth in claim 2, wherein the gap is between a platform of a vane, and a spaced housing.

4. The gas turbine engine as set forth in claim 3, wherein a second gap surrounds the head of a securement member.

5. The gas turbine engine as set forth in claim 3, wherein a vane extends between a pair of inner and outer wall surfaces, and has platforms attached to each of said inner and outer wall surfaces, and said gap includes recesses around a head of a securement member which secures said inner and outer platforms to associated housings.

6. The gas turbine engine as set forth in claim 5, wherein said gap also includes a space between both said inner and outer platforms and an associated housing.

7. The gas turbine engine as set forth in claim 5, wherein said vane sits in a bypass duct.

8. The gas turbine engine as set forth in claim 2, wherein a vane extends between a pair of inner and outer wall surfaces, and has platforms attached to each of said inner and outer wall surfaces, and said gap includes recesses around a head of a securement member which secures said inner and outer platforms to associated housings.

9. A method of smoothing an aerodynamic surface in a gas turbine engine comprising:
depositing a thermoplastic into a gap in a surface configured for being in a gas flow path, the surface including at least one structural member defining a gap; and
smoothing the surface to remove excess thermoplastic to provide better aerodynamic efficiency whereby the surface aerodynamically and smoothly continuous over a gap area.

10. The method as set forth in claim 9, wherein the surface including at least two structural members spaced in the gap area.

11. The method as set forth in claim 10, wherein the gap is between a platform of a vane, and a spaced housing.

12. The method as set forth in claim 11, wherein the gap surrounds the head of a securement member.

13. The method as set forth in claim 11, wherein a vane extends between a pair of inner and outer wall surfaces, and has platforms attached to each of said inner and outer wall surfaces, and said gap includes recesses around a head of the securement member which secures said inner and outer platforms to associated housings.

14. The method as set forth in claim 13, wherein said gap also includes a space between both said inner and outer platforms and an associated housing.

15. The method as set forth in claim 13, wherein said vane sits in a bypass duct.

16. The method as set forth in claim 9, wherein the gap surrounds the head of a securement member.
